(19) United States
(12) Patent Application Publication
(10) Pub. No.: US 2024/0403403 A1
(43) Pub. Date: Dec. 5, 2024

(54) IDENTITY VERIFICATION AND ASSOCIATED PLATFORM

(71) Applicant: Cryptic Labs LLC, Sunnyvale, CA (US)

(72) Inventors: Albert C. Brown, San Juan Capistrano, CA (US); Yinchao Wang, Sunnyvale, CA (US)

(73) Assignee: Cryptic Labs LLC, Sunnyvale, CA (US)

(21) Appl. No.: 18/803,408

(22) Filed: Aug. 13, 2024

Related U.S. Application Data
(63) Continuation of application No. PCT/US2023/062532, filed on Feb. 14, 2023.
(60) Provisional application No. 63/267,993, filed on Feb. 14, 2022.

(51) Int. Cl. G06F 21/32; G06Q 20/36

(52) U.S. Cl. CPC G06F 21/32; G06Q 20/36; G06Q 2220/00

(57) ABSTRACT

A Web3 identity is created with a digital residency platform and verification system using a user's root legal identity. The digital residency platform and verification system and methods associated therewith include a blockchain-native digital residency platform that bridges the privacy and security of Web3 identity with the capabilities and validity of global sovereignties.

### PRIORITY

The instant application claims priority as a continuation of International Application No. PCT/US2023/062532, filed Feb. 14, 2023, which claims priority to U.S. Provisional Patent Application 63/267,993, filed Feb. 14, 2022, each of which is incorporated herein in its entirety.

### BACKGROUND

As global connectivity leads people towards a multiverse, the presence of artificial borders created by juristic entities restricts innovation and business activity. For example, money transfers may be limited from one country to another. Having rights to do business in one nation does not transfer rights to do business in another country. Siloed intellectual property rules and other regulated rights that are geography-dependent similarly hinder innovation, commercialization, and expansion of global knowledge.

### SUMMARY

The ability to transcend borders is hindered by the control imposed by individual jurisdictions. Blockchain and open ledger technology may have a potential of overcoming these boundaries as it may limit the control available to any single jurisdiction or entity. However, conventional blockchain solutions are constrained entirely to the virtual world and do not provide solutions in the physical world to permit physical transactions or benefits to be realized. Without the legitimacy of sovereign and legal institutions underpinning the blockchain, there is a limit to the use of blockchain technology to create a solution as described herein. Exemplary embodiments therefore relate to a digital residency and global citizenship platform that retain the physical legitimacy of the sovereign and legal institution but can use the digital blockchain for privacy and security. Exemplary embodiments, therefore, may include a blockchain-native digital residency platform that bridges the privacy and security of Web3 identity with the capabilities and validity of global sovereignties.

Exemplary embodiments of this first Web3 identity platform may be generated using end-to-end encryption enabling users to have control over their data and identity exposure. Exemplary embodiments may leverage non-fungible tokens (NFTs) as decentralized identifiers (dID) documents and zero knowledge proofs (ZKPs).

Exemplary embodiments described herein may provide claims associated with the identification that permits systems to confirm credentials without providing personally identifiable information. For example, the identity saved as an NFT may include characteristics of the individual, such as age range, age group, eye color, height, weight, gender, organizations, political affiliation, etc. that may be confirmed such as ID credentials that does not have to disclose personal information.

Exemplary embodiments described herein provide a digital verification system. Exemplary embodiments may permit borderless capabilities to support global infrastructure. Exemplary embodiments may be used to provide verification for residency, banking, brokerage, incorporation, business formations, among other applications.

### DRAWINGS

FIG. 1 illustrates an exemplary identification provided by embodiments described herein.

FIG. 2 illustrates an exemplary block diagram of the technical overview of a new identification platform according to embodiments described herein.

FIG. 3 illustrates an exemplary block diagram of the technical overview of a new identification platform according to embodiments described herein.

FIG. 4 illustrates an exemplary flow diagram of methods of a new identification workflow according to embodiments described herein.

FIG. 5 illustrates an exemplary flow diagram of methods of a new identification workflow according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described herein provide for a digital residency platform and verification system and method. The system may comprise a blockchain-native digital residency platform that may bridge the privacy and security for residency verification with the capability and validity of global sovereignties. Exemplary embodiments may be used for a global and borderless infrastructure to support new digital experiences across the world. Exemplary applications of the digital residency platform may be used to support and/or permit digital residency verification, digitally signing documents, e-banking and/ore-brokerage services, remote incorporation of business entities, personal characteristic verification, among others. Exemplary embodiments of the digital residency platform and verification system and method described herein may support multiple residencies for its users, may provide consistent user experiences globally and across jurisdictions, and/or may provide sovereign legal support.

Exemplary embodiments of a digital residency platform and verification system and method described herein offers a tethered legal physical address backed and officially recognized by partner sovereign polities. Exemplary embodiments may use physical verification through sovereign states to equip residence with legally recognizable and digital residency. Based on the recognized and digital residency, residents can have access to services provided by entities associated with the sovereign of the residence or its affiliates or partners. Services can be enabled by partner countries, including, for example, financial services such as banking and brokerage. A spectrum of digital services can also be provided such as corporate formation and operation. Exemplary embodiments may also permit global registries such as for intellectual property filings, or marketplaces. The platform and associated methods may also permit dual residency or multiple residency capabilities. The platform and associated methods may also provide options for validating information about an individual or entity while keeping private certain information (such as personally identifiable information).

Exemplary embodiments of a digital residency platform and verification system and method described herein provides a real legal identification (ID) system for global citizens backed by sovereign laws and implemented through non-fungible tokens (NFTs). Exemplary embodiments may permit legal identification verification using an open ledger system, i.e. blockchain. Exemplary embodiments may permit root identity that supports public chains. Exemplary embodiments may provide digital identification backed by NFT. Exemplary embodiments may permit legal recognition with sovereignty issued real identification. Exemplary embodiments may use zero knowledge proofs supported to protect privacy. Exemplary embodiments may enable services to be provided on an itemized level from a jurisdiction marketplace. Exemplary embodiments may use digital identification disclosed only using know your customer (KYC) when authorized by a holder.

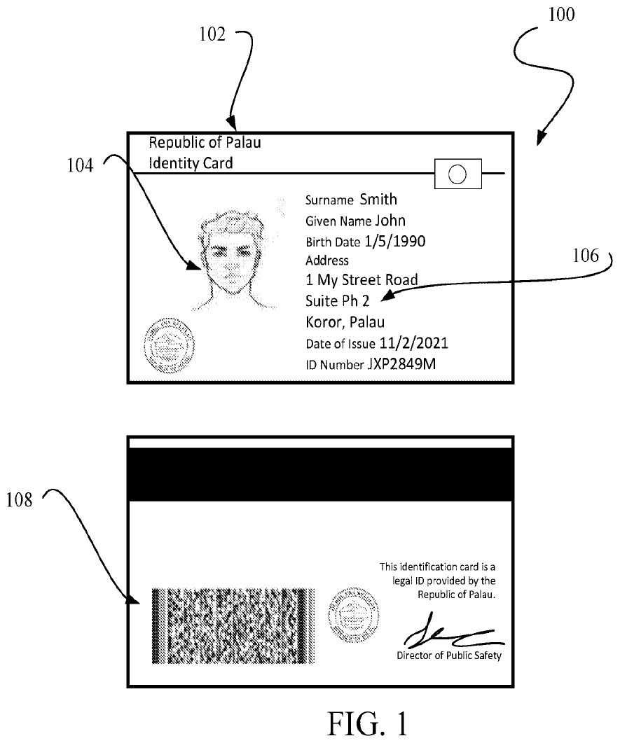

FIG. 1 illustrates an exemplary identification provided by embodiments described herein. As illustrated, the photo identification 100 can include the issuing sovereignty 102, the user's image 104, and information 106 about the user and/or the identification. For example, information about the user may include name, birthday, address, gender, eye color, hair color, weight, height, etc. or any combination of information. Information about the identification may include, for example, identification number, issuing date, expiration date, etc. or any combination of information. The identification card may have one or more digital markers 108 that permit the identification card to be recognized by a scanner or other computer input. For example, digital marker 108 of the identification card 100 may include a magnetic strip, bar code, QR code, radio frequency identification (RFID) tag, or any combination thereof.

The identification provided herein may be a physical identification card, such as, for example, a passport, school identification, driver's license, government issued identification, employee identification, etc. The identification may also or alternatively be a digital identification that includes the same information that may be used as an image on an electronic device to identify a person and/or user.

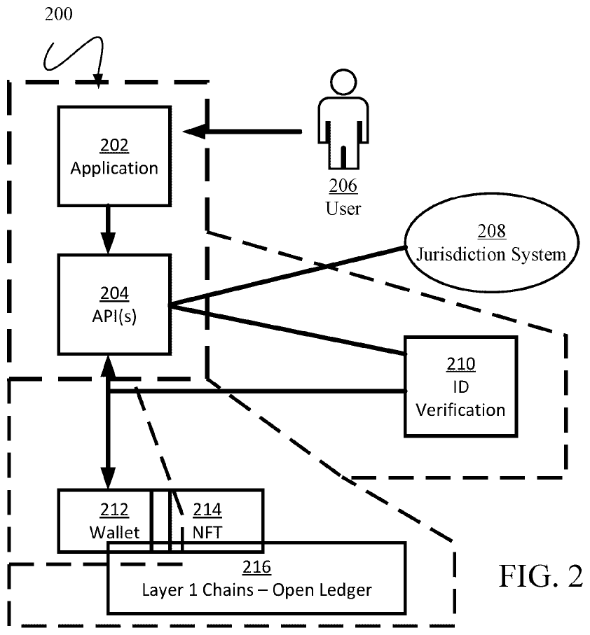

FIG. 2 illustrates an exemplary block diagram of the technical overview of a new identification verification system according to embodiments of the invention.

In an exemplary embodiment, the identification verification system may include an application 202 that may interface with other programs and systems using an application program interface (API) 204.

In an exemplary embodiment, the application 202, either directly or through the API 204, may interface with an open ledger system 216 and one or more user's wallets 212. In an exemplary embodiment, the user's wallet may be integrated into or part of the application 202 and/or the verification system described herein. In an exemplary embodiment, the user's wallet may be external to the application 202, and the application 202 may be configured to communicate or interface with the user's wallet. In the same way, the identification verification system may include the open ledger or may be configured to interface and/or communicate with the open ledger, such as through the application 202 and/or API 204.

As illustrated by the dashed lines, the verification system 200 may comprise different component parts. For example, the verification system 200 may comprise the application 202 and/or API 204. The verification system 200 may be configured to communicate with external systems, such as an open ledger, user wallet, and ID verification system 210. The verification system 200 may also include the ID verification system 210, which may be integrated into the application 202, or may be separate and communicate with the application 202, but remain within the communication/control of the verification system. The verification system 200 may also or alternatively include the user's wallet that can interface with the open ledger that may be external to the verification system, where the open ledger may either be within the verification system and/or external to it. Accordingly, an exemplary embodiment of the verification system comprises an application with or without an API in order to communicate and interface with other systems that may include a verification system, an open ledger, user wallet, and combinations thereof. An exemplary embodiment of the verification system comprises an application with or without an API as well as an identification verification system, where the application and/or API may be configured to communicate with an open ledger and/or user wallet. An exemplary embodiment of the verification system comprises an application with or without an API as well as a user's wallet configured to communicate with an open ledger, where the application and/or API are configured to communicate with an identification system. An exemplary embodiment of the verification system comprises an application with or without an API as well as a user's wallet in communication with an open ledger, where the application and/or API are configured to communicate with an identification verification system. An exemplary embodiment of the verification system comprises an application with or without an API, a user wallet configured to communicate with an external open ledger and an ID verification system in communication with the application. An exemplary embodiment of the verification comprises an application with or without an API, a user wallet in communication with an open ledger, and an ID-verification system in communication with the application.

In an exemplary embodiment, the application 202 may include non-transitory program instructions stored on one or more memory device(s) that are executed by one or more processor(s) to perform the functions described herein. In an exemplary embodiment, the user may access the application through a web interface. For example, the user may user a user electronic device, such as a mobile phone, computer, laptop, etc. to access a browser and communication with the application over a network, such as the internet. In an exemplary embodiment, the user may access the application through a user device. The application may be stored on a user's device, such as a mobile phone, computer, laptop, tablet, etc. and execute the application to perform the functions described herein. The application may communicate with part of the application or a remote application stored on a remote communicating device, such as a server, so that the application resides across the server and the user's device.

As illustrated, the application 202 may include a user interface configured to permit a user 206 to communicate with the application 202. The user interface may be displayed on an electronic device and may provide information to the user. The user interface may also include inputs to receive information from the user, such as through gestures, mouse, keyboard, etc.

In an exemplary embodiment, an exemplary verification system 200 comprises an application 202. The application 202 is configured to permit the user to access the system such as through an application stored on the user's device and/or through a website. The application 202 is configured to create a user identification. The system may be configured to receive information from the user and populate a database. The user information may be used to populate the information in the database about the user identification. For example, the user identification may include a user's image, name, birthday, address, e-mail, phone number, country of residence, citizenship, country of registration, etc, or a combination thereof. The application may also be configured to permit the user to create a username and password or other log in credential combination (including, for example, biometrics), to permit access to the application by the user.

In an exemplary embodiment, the system may include or communicate with a blockchain 216, such as, for example, Ethereum, BSC, among others. A blockchain is a digitally distributed, decentralized, public ledger that exists across a network.

In an exemplary embodiment, the system may include or communicate with a digital wallet 212. The wallet is a digital interface to permit users to store, exchange/transact, or view information about their account as it relates to entries on a blockchain ledger (such as, for example, monitoring or exchanging cryptocurrencies owned by the user). The wallet 212 may be configured to retain one or more non-fungible tokens (NFTs) 214 according to embodiments described herein.

In an exemplary embodiment, the system may include or communicate with an identification verification system 210. The identification verification system may be configured to receive identification documents. The identification document may be, for example, the identification of FIG. 1 issued by a recognized sovereign jurisdiction 208. The identification document may be, for example, a driver's license, state or country issued ID, passport, etc. The identification verification system 210 may be configured to receive the identification document, for example, by taking receiving a digital image such as from a picture and/or retrieving a digital scan or image of the document. The identification verification system 210 may permit the user to navigate to a stored data file comprising the image of the identification document to upload the stored data file to the identification verification system 210. The system may permit the user to use a camera or other image retrieving device to take a picture of the identification document and generate a data file comprising the image of the identification document to send to the system components as described herein. The system may also permit the user to provide other information about the identification document, such as an identification number, birthday, issue date, expiration date, etc. The system alternatively or additionally may use image processing to recognize the image of the identification document from the data file and retrieve desired information from the document, such as the legal name of the user, birthdate, issuing jurisdiction, date of issue, date of expiration, etc.

In an exemplary embodiment, the identification verification system 210 is configured to validate the identification document. The document may be validated in one or more ways. For example, the user may be required to set an appointment with a validator in which the user is present with another person so that the person can confirm the identity of the user as compared to the identification document. The user may be required to appear on camera with the user and present the identification document so that the person can compare the image on the identification document with the image of the user on the video and on the uploaded image of the identification document received through the identification system. The document may be validated through an artificial intelligence method using face recognition, object recognition and analytics to determine that a false image is not being provided in place of the user. For example, the system may detect natural movement of the user as the user takes a video of their face, and the document so that that the identification verification system can confirm and compare the image of the user against the image of the identification document. The system may also be configured to compare publicly available information to receive additional information about the user to validate the identification document and/or the user. For example, social media information may be used for additional image recognition and/or training for the individual user. Social media may also or alternatively provide location information to confirm the location of the user when the user confirms their identification. Exemplary embodiments of the identification system may include optical character recognition to extract document detail to enter information about the identification document into the system. Exemplary embodiments may use other techniques, a combination of techniques, to digitally and/or manually validate the user and/or the identification document. In addition, the document verification can be outsourced to additional id verification technology providers.

In an optional part of the verification system, the system may be configured to communicate with a jurisdictional system 208. The application may be configured to send a copy of a digital identification to the jurisdictional system for recording, saving, or for other record keeping. In an exemplary embodiment, the application may create and encrypt the digital identification and send or otherwise communicate the digital identification to the sovereign jurisdiction system. In an exemplary embodiment, the digital identification may be an image of the identification document. Exemplary embodiments of the digital identification may be used by the jurisdiction to create or support the digital identification and/or the verification system. The encrypted file of the source identification document may be stored in cold storage such as writing the encrypted contents to an USB drive and then removing the USB drive from the system.

Once verified, the identification verification system may communicate with the application to receive a copy of the digital identification. In an exemplary embodiment, the application may include the portion of the identification verification system so that the application receives an image of the identification. The application may then communicate the requisite information to the identification verification system in order to confirm or validate the user and/or the identification. In this case, the identification verification may directly use the digital identification.

In an exemplary embodiment, identification verification system may, such as through the application, create a non-fungible token for verification. The token may be configured to relate to the sovereign jurisdiction and the user generated identification. The token may be configured to contain base information about the verified identity/identification, which may, for example, include a document id number, the jurisdiction, the verification URL, and one or more claims. Exemplary embodiments of the NFT may permit one or more claims to be saved with the NFT as metadata. One or more claims of the NFT may be, for example, age ranges, over 18, over 21, gender identity, sex at birth, height, birthdate, etc. The claims can be age related claims such as Over18, Over21, Sex at Birth Claims, as well as hashed claims that their name when hashed is the same as the claim. Exemplary claims can be extended to all biographical data the platform knows about the person, such as state of residency, among other information. The hashed claims provide validation that when the information is retrieved by a third party through the platform verification system, the information is correct and matches the hashes stored in the id token. Exemplary embodiments may therefore be used to confirm or verification information about the identification without revealing other information about the user. Exemplary embodiments may be used to provide, for example, Boolean confirmation that a condition exists for the person, e.g. is above a certain age, is at least a certain height, is of a certain gender at birth, etc.

Exemplary embodiments of the identification non-fungible token (NFT) is used by embodiments described herein to represent an identification of a user that can be verified, matched to a person and placed into the wallet of the user.

In an exemplary embodiment, the verification system described herein may include one or more NFTs associated with one or more users. An individual identification NFT of the one or more NFTs may be through the system and methods described herein bound to a specific and individual user of the one or more users of the system. The NFT may thereafter be non-transferrable so that the same NFT stays bound to the same user and the identification verification of the user stays with the NFT and the user to permit continued confirmation of the identification (or the claims) through the NFT. Exemplary embodiments therefore provide preventions to transfer the NFT from one user wallet or user to another user wallet or user. Exemplary embodiments of the NFT, are also configured to be non-fungible, so that they cannot be duplicated or split. The NFT is therefore unique once it is minted and stays with the same user that was used to create the NFT.

Of particular interest, the NFT may comprise one or more claims associated with the NFT. In an exemplary embodiment, the NFT may comprise metadata that comprises claims associated with the identification. In an exemplary embodiment, the claims may include non-personally identifiable claims. In an exemplary embodiment, the claims may be Boolean claims. For example, the one or more claims may be true or false statements about specific characteristics, such as age range, yes or no over 18 years old, yes or no over 21 years old, yes or no over 56 inches height, yes or no for female, yes or no for male, etc. Exemplary embodiments may therefore provide access to one or more of the claims to provide confirmation that a user meets the given claim without providing personally identifiable information. This may be used to provide access to a location, such as to permit someone into a bar that is over 21 but not to those that are under 21 by simply confirming a user's age based on the claim.

Exemplary embodiments of the system described herein, the user may control visibility to one or more of the claims. The user may therefore select which claims are accessible through the system or by select vendors or third parties.

Exemplary embodiments of the system described herein include NFTs that are tamperproof. The NFT, therefore, once verified may be used to continue to verify the user and/or the claim associated with the user without concern that the token has been modified.

In an optional exemplary embodiment, the identification verification system 200, such as through the application 202, may be configured to generates a new identification document for the jurisdiction. The new identification document may include personal information, similar to other jurisdictional issued identifications, such as, for example, picture, name, address, citizenship, birthday, etc. The new identification document does not have to include any or all of the personal information. The new identification document may be provided or shipped to the user at an address provided by the user or other known location for the user to pick up. The verification system may create the new identification document by communicating the requisite information to a third party, such as the jurisdictional system 208 in order to issue the new identification document. The system may also or alternatively directly create/print the new identification document for the user.

In an exemplary embodiment, the identification verification system is configured to expunge or not retain a copy or memory of the identification document that was originally provided to confirm the identity of the user. The identification verification system may therefore provide an additional layer of security as the personal information associated with the new identification document is not retained, and therefore not accessible for misappropriation or exposure.

Exemplary embodiments of the digital residency platform and verification system comprise a user interface module, application program interface, identification verification module, wallet generation and communication to a blockchain open ledger module. Each of the modules may include one or more processors in communication with memory, whether local, remote, and/or distributed, that is configured to perform the functions described herein.

Exemplary embodiments of the digital residency platform and verification system comprise a user interface module. In an exemplary embodiment, the user interface module may be part of application 202. The user interface may be generated using a downloadable application on an electronic device and/or through a browser or other electronic interface that communicates to a remote server and displays information to the user on the electronic device. The user interface functions may include, for example, providing a user interface to permit the user to create an identification according to embodiments described herein. The user interface module may provide the user with a user interface for providing user information such as, for example, any combination of name, address, residency, citizenship, desired jurisdiction, user name, e-mail, phone number, password, credentials, biometrics, etc.

Exemplary embodiment of the digital residency platform and verification system comprise application program interface (API) 204 for communicating between the application 202 and the other parts of the system, such as, for example, the digital wallet 212 and/or block chain 216, the jurisdictional system 208, and/or the identification verification system 210. The API may be configured to send and receive information based on the interfaces of the one or more different systems.

Exemplary embodiments of the digital residency platform and verification system comprise an identification verification module 210. The identification verification module functions to receive the encrypted identification document from the App 202, such as through the API 204, and validate the original ID document. The identification verification module may therefore communicate back an approved or disapproved indication to the system before the system generates or creates the NFT 214 or new identification documents according to embodiments described herein.

Exemplary embodiments of the digital residency platform and verification system comprises a wallet generation and communication to a blockchain open ledger module. The function of the wallet generation and communication to a blockchain open ledger module is to generate a digital wallet 212 and communicate with the block chain 216 to read, write, or otherwise perform the functions described herein to transfer or retain or verify the relationship of the wallet 212 to an NFT 214 or other token described herein.

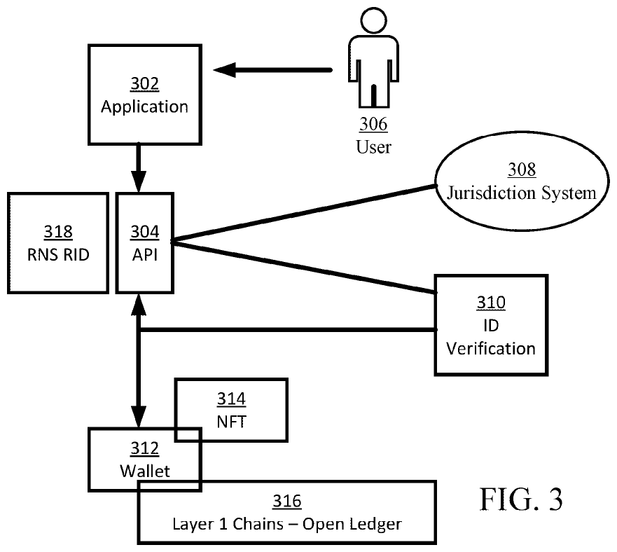

FIG. 3 illustrates an exemplary block diagram of the technical overview of a new identification system according to embodiments of the invention. The exemplary embodiment illustrated in FIG. 2 is directed at the technical overview in the creation of the new identification, while FIG. 3 illustrates a similar workflow for know your client (KYC) systems.

In this case, the system 300 does not include cold storage in which information is sent to the jurisdictional system 308. Instead, the system may encrypt the identification document and send it to the jurisdiction system. In the embodiment of FIG. 3, the system may include an identification system 318. The identification system 318 may by the system to generate the new identification document described with respect to FIG. 2 that is provided to the customer and stored on the blockchain. In an exemplary embodiment, the identification system 318 may use source document(s) and a user photo to generate the new identification document after the user through the user documents is verified by the identification verification system 310. The new identification document may be issued, and sent to an object store, file system or queue for the Jurisdiction that granted the residency platform the authority to create the new identification document for that Jurisdiction. The Jurisdiction may keep the source information or move to an alternate system. After the source information is moved to the Jurisdiction system, that information may then be completely removed from the system.

The exemplary embodiment of FIG. 3 may have features similar to those of FIG. 2, including, for example, the application 302 that permits a user 306 to create a new identity in the identification and verification system described herein, that ultimately generates an NFT 314 stored on an open ledger 316 and accessed by the user through their digital wallet 312 to confirm different attributes of the user through the identification verification system 310.

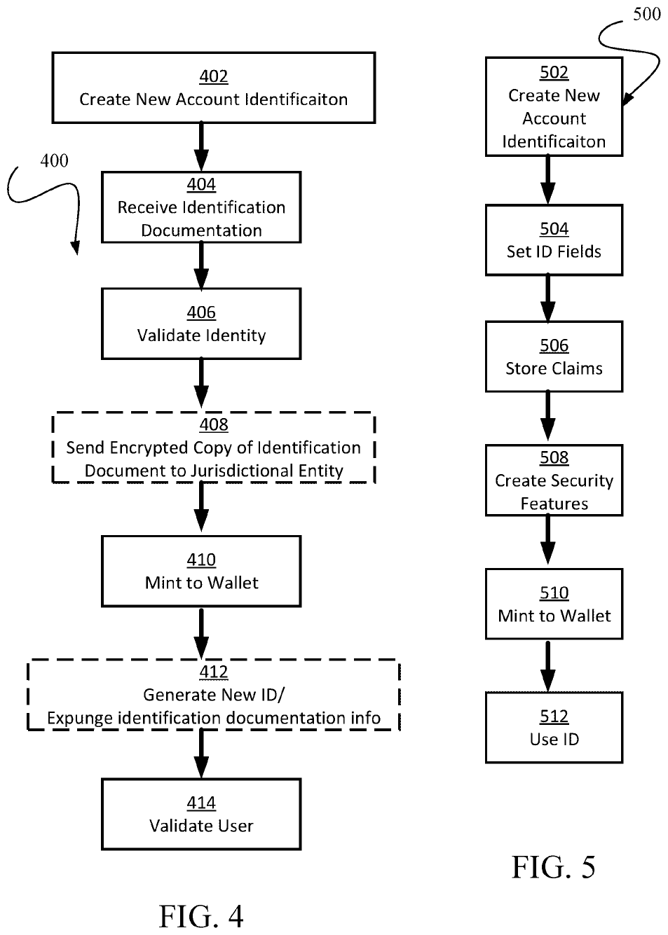

FIG. 4 illustrates an exemplary block diagram of the overview of a new identification method 400 according to embodiments of the invention.

First (step 402), the user enters the digital residency platform and verification system and creates an identification. The user may access the system through an application or a website interface. The user may create an identification by entering information into the system, such as, for example, providing a user image, entering a name, birthday, address, country of residence, citizenship, desired country of registration, height, weight, eye color, hair color, or any combination of information. The user may also create or provide a username, e-mail, and/or password or other combination of credentials (such as biometrics) for entering the system.

When creating the Identification, the system creates a digital wallet for the user. The digital wallet is in communication with a blockchain network, such as Ethereum, BSC, others, or a combination thereof. The blockchain is a digitally distributed, decentralized, public ledger that exists across a network. The wallet is a digital interface to permit users to store, exchange/transact, or view information about their account as it relates to entries on a blockchain ledger (such as, for example, monitoring or exchanging cryptocurrencies owned by the user).

Then (step 404), the user, through the digital residency platform and verification system (such as through the downloadable application or website browser interface), uploads one or more identification document(s). The identification document(s) may be, for example, the identification of FIG. 1 issued by a recognized sovereign jurisdiction. The identification document may be, for example, a driver's license, state or country issued ID, passport, school identification, state identification, company identification, etc. Although discussed generally in terms of a jurisdictional entity, exemplary embodiments described herein may be used by companies for generating employee or user identifications that may be used to provide access and/or privileges to different users.

The user may upload the identification document, for example, by taking a picture and/or retrieving a digital scan or image of the document. The system may permit the user to navigate to a stored data file comprising the image of the identification document to upload the stored data file to the system. The system may permit the user to use a camera or other image retrieving device to take a picture of the identification document and generate a data file comprising the image of the identification document to send to the system components as described herein. The system may also permit the user to provide other information about the identification document, such as by entering through a user interface an identification number, birthday, issue date, expiration date, etc. The system alternatively or additionally be able to using image processing to recognize the image of the identification document from the data file and retrieve desired information from the document.

Next (step 406), the digital residency platform and verification system validates the identification document(s). The document(s) may be validated either automatically with machine learning and/or artificial intelligence through face recognition, optical character recognition for document detail extraction and other various techniques or manually through a manual review process. In addition, the document verification can be outsourced to additional id verification technology providers.

Then (step 408), the digital residency platform and verification system may optionally encrypt the image of the identification document and send the encrypted file to the sovereign jurisdiction system of the user's selected jurisdiction to create or support the digital identification. The encrypted file of the source identification document may also be stored in cold storage such as writing the encrypted contents to an USB drive and then removing the USB drive from the system.

Next (step 410), the digital residency platform and verification system creates a non-fungible token for verification. The token relates to the sovereign jurisdiction and the user generated identification, generated at step 402. The token contains base information about the verified identity which may include any combination of, for example, the document id number, the jurisdiction, the verification URL, and a few claims. The claims may be any feature of the user that the system is used to verify. For example, the claims may be age related claims such as Over18, Over21. The claims may be sex at birth claims. The claims may be hashed claims of personal or confidential information, such as the name when hashed is the same as the claim. Claims may extended to all or any combination of biographical data the platform knows about the person, such as residency location, age, age range, gender, height, height range, gender, political affiliations, access levels, etc.

Next (step 412), the digital residency platform and verification system may optionally generate a new identification document for the jurisdiction. The new identification document may include personal information, similar to other jurisdictional issued identifications, such as, for example, picture, name, address, citizenship, birthday, etc. The new identification document does not have to include any or all of the personal information. The new identification document may be provided or shipped to the user at an address provided to by the user or other known location for the user to pick up. In an exemplary embodiment, the system may be configured to generate the new identification document. The new identification document may then be picked up by the user, mailed to the user, or otherwise provided to the user.

In an exemplary embodiment, the digital residency platform and verification system expunges any memory of the received identification document. The system method may therefore erase or otherwise does not retain a copy or memory of the identification document that was originally provided, such as at steps 404-406. The digital residency platform and verification system may therefore provide an additional layer of security as the personal information associated with the identification document is not retained, and therefore not accessible for misappropriation or exposure. Other specific information may also be expunged or not retained to improve the security of the system and the user. For example, select personal identifiable information may be expunged.

In an exemplary embodiment, information may be stored in hashed or encrypted format. For example, one or more of the claims may be hashed to provide validation that when the information is retrieved by a third party through the platform verification system, the information is correct and matches the hashes stored in the id token.

Finally (step 414), one or more of the claims may be used to validate an attribute of the user. For example, a third party may observe one or more claims of the NFT to confirm the attribute of the user. In an exemplary embodiment, a user provides an attribute of the new identification to their system that computes with the application in order to confirm a desired attribute of the user. The system then retrieves or confirms the claim against the user profile.

FIG. 5 illustrates an exemplary block diagram of the overview of a new identification method 500 according to embodiments of the disclosure for generating an NFT according to embodiments described herein.

First (step 502), a user creates a new account. This step may include the same or similar features as the step 402 described with respect to FIG. 4. In an exemplary embodiment, a new identification is created by the system. The system may obtain information about the user, including the user's name, gender, age, residency, etc. The system may also obtain information about one or more identification documents, such as, for example, driver's license, passport, physical identification, etc. The system may obtain information about the physical identification, including, for example, issuing entity/jurisdiction (this may be a country government, or corporate entity, government entity, jurisdiction, etc.); identification type (this may be a passport, driver's license, identification, etc.); document identification number; document issue date; document expiration date; etc. Additional information may also be obtained and retained in the system, for example, address, eye color, hair color weight, height, birthdate, etc.

Then (step 504), the system sets the new identification fields. From the information received from the original identification document and/or from the user and/or from public information and/or from the jurisdictional entity and/or other sources, the system may be configured to set identification fields. The identification fields may be any information associated with the new identification. This may include any information associated with the original identification and/or the user.

Next (step 506), the system uses any of the identification information to create claims statements. In an exemplary embodiment, claims are configured as statements that are saved with the NFT and can be made on behalf of the original identification or specific information about the user without revealing the underlying information. For example, an age claim may be made that a user is under 13, over 16, over 18, or over 21, without revealing the birthday of the user. Claims may also be statements about the information directly about the user or the identification document that is in a different form that permits comparison of information but that does not provide the information directly. For example, the gender, age, name, photo, etc. of the user or from the original identification document may be hashed or otherwise encrypted to provide a data source that can be compared but that itself does not provide the information. Exemplary embodiments may therefore use the same hashing algorithm to input information into the system for comparison as is saved with the NFT and if the two hashes match, then the information can be confirmed or denied when the two hashes do not match. Information may be confirmed or verified without actually storing the information with the NFT so that the privacy can be maintained.

Exemplary embodiments of the new identification may include any combination of information, such as, for example, name, birthday, jurisdiction, expiration, address, eye color, hair color, weight, gender, identification number, etc.

Exemplary embodiments of NFT may include information, such as, for example, information related to the person, information related to the document originating the identification verification, checks, new identification information. Exemplary embodiment of the NFT may include information that can be subject to the user's approval or may be set to be sharable based on the user's approval. Exemplary embodiments of information related to the person may include, for example, eye color, hair color, weight, height, birthdate, name, etc. Exemplary embodiments of information related to the source document used for verification may include for example source identification number, issue date, expiration date, issuing jurisdiction.

Exemplary embodiments of the NFT may include any combination of claims associated with the NFT, such as, for example, new identification number, jurisdiction, identification type, gender, validity Boolean, age related information. An age related information may be an over/under a specific age, the specific age may be related to an age restriction in which the identification may be used to confirm. For example, an age may be over 16 or 18 to determine if the user can drive with or without restrictions, over 21 to determine if the user can drink, under 13 to determine if the person is a child or may need content restrictions. Identification type may include information related to the purpose of the identification, such as, for example, drivers license, passport, identifier, etc. Gender may include a male or female designation. The validity of the identification may be a Boolean true/false identifier to indicate whether the identification was still valid or not. Exemplary embodiment of the NFT may include claims that can be subject to the user's approval or may be set to be sharable based on the user's approval. Claims may also include, for example, whether the user is under sanctions or other restrictions.

At step 508, security features may be added so limit modification or tampering of the NFT data including, for example user related information and/or claims. In an exemplary embodiment, metadata on the identification as well as any images and other information of the NFT should be secure so that it cannot be modified or tapered with. Cryptographic hashes may be used to confirm the information of the NFT according to embodiments described herein. In an exemplary embodiment, cryptographic hashes may be calculated and stored on the blockchain as first class citizens in the identification NFT. In an exemplary embodiment, information related to the NFT may be hashed and stored on the blockchain. In an exemplary embodiment, the hash version or standard may be stored on the blockchain along with the root hash. The hash may be taken, for example, of the original document identification number, original document photograph and/or image, identification document issue date, identification document expiration date, whether the identification document is valid, new document identification number, new identification issue date, jurisdiction, identification type, user name, birthdate, gender, new document photograph, personal photograph, or any other information as described herein relative to the original document, the user, or the new identification. If a field is not available or no information is entered for a given field used in the hash, then an empty string may be used in its place.

Claims may also include tamper proof claims, such as, for example, merkle root cryptographic hash, a hash of the user's photo, a hash of other attributes of the NFT information, original document information, and/or NFT claims.

In an exemplary embodiment, the claims may be stored in metatdata URL. To avoid changing the IPFS and URL to metadatajson file, the URL may be something like https://api.ms.id.nft/<internal_id>.json. Since the URL is against the backend of the system, the API can return different JSON contents each time it is retrieved.

In an exemplary optional embodiment, the NFT metadata may change, such as using opensea indexing of properties. The system may be configured to publish an event periodically, such as once a day if the claims have change don the NFT.

At step 510, and after entering in information and/or verification the identification of the user, the user can mint an NFT to their wallet. The user may confirm the intent to mint to their wallet, and provide or select the desired wallet. In an exemplary embodiment, the frontend of the system may save the wallet address, account, and identification information to the backend database. Upon saving, the web3 method may call the authorization of a mint to a certain address. The associated fees may be moved for the services rendered and the generation of the NFT. The user interface may inform the user that the NFT will be airdropped into their wallet within a given time frame or to a given address/chain combination. The backend of the system is configured to listen to the event from the blockchain. When identified on the blockchain, the address in the database is looked up to determine if the address exists, and confirmed the ID is airdropped. The address is removed from the database of pending identifications to be airdropped. If the address does not exist on the blockchain, then the event to airdrop may be ignored. When the identification is airdropped, a new token is created, and the security is set using the security hash (the merkle hash described above as an example), and the url is set, and the stores the information related to the NFT. When the new identification event is recorded on the blockchain, then a mapping is created with the identification of the new identification, the token identifier, etc. are saved.

Finally, (step 512), the open ledger, NFT, and new identification can be used by the user. In an exemplary embodiment, the claims may be used to confirm an attribute about the user without providing personal information about the user. For example, one or more claims may be retrieved using the json URL described herein.

As illustrated above with respect to the exemplary block diagrams of the technical system and methods associated therewith, exemplary embodiments described herein generate a token that can be used as the only and ultimate certificate in the Web3 ecosystem. The generated token reflects the individuals availability and participation in anything in which the digital residency platform and verification system is used to verify the user. For example, the generated token may be used to confirm the user is in a desired age group, is or is not part of a restricted classification, is over or under a necessary height, or any other attribute that needs to be confirmed. In an exemplary embodiment, the claims may include whether the user is part of a desired class, such as an accredited investor, political party, etc. The Web3 identity document (NFT) is generated using the user's root legal identity, as evidence by the original identification document of the jurisdiction. The root legal identity may be other attributes of the user. Preferably the root legal identity is tied to a confirmed individual user in relation to a sovereign jurisdiction. This relationship may be through citizenship, residency, or other relationship. The digital residency platform and verification system uses the root legal identity and end-to-end encryption to control the user's data and identity exposure. In the embodiment in which the original identification document is not retained in the system, the system may increase security and data/identity exposure for the future and during further transactions/verification using the system.

At a bigger picture, exemplary embodiment of the system and methods described herein may provide universal citizenship card for a global ecosystem. Users may obtain digital residency at a jurisdiction of their choice. Exemplary embodiments of the digital residency may be legally backed by a sovereign state. Exemplary embodiments may use optional automated know your customer (KYC) and/or anti-money laundering (AML) for additional security. Exemplary embodiments may provide sanction proof if a user is not on a sanctioned list. Exemplary embodiments may provide a decentralized autonomous organization (DAO) for governance on jurisdiction support. Each jurisdiction may have different benefits, such as, for example, different income tax rates.

The digital residency platform may leverage a token that members that use the platform services may acquire. The platform could then use up those tokens as the member consumers different services as described herein.

Exemplary tokens generated with the use of the digital residency platform and verification system may be provided based on support, registration, referrals, or any combination thereof. Each service provided by the system may consume tokens on a monthly (or other time interval) basis depending on a user's tier level. Users can earn tokens by performing tasks such as referring others to the system, finishing profiles, providing information to the system, upgrading their status such as in tier upgrades/NFTs.

The NFT's generated according to the workflows described herein may work on top of the token to generate or grant tiered privileges. For example, the following NFTs may be generated with the associated privileges: Citizen ID NFT, which can be a basic identification non-fungible token that is non-transferable from the user. Status NFT, which may be any status or participation in the jurisdiction and/or group, such as, for example, governor, ambassador, delegate. The Status NFT may be transferrable based on the participation of the user in any given status category. Country/Service NFT, which may be provided by the jurisdiction and created for different services launched in the jurisdiction. Exemplary embodiments of the country/service NFT may be minted for each service launched in the jurisdiction using culture representation from the jurisdiction as the base. Optionally, the NFTs can be signed by a jurisdiction or an artist or other creator. Exemplary embodiments of the country/service NFT may be used as badges or shown on the user profile.

Exemplary embodiments of a digital residency platform and verification system and method may be powered by tokens that reflects the individual's participation in activities, such as, for example, governance, distributed applications, NFTs, real life activities, memberships, etc. Exemplary embodiments of the token may be used to unlock various levels of rights, both virtually, and physically. Examples of virtual rights may include real-time identity verification, while physical rights may include access to banking, memberships, and other privileges. Exemplary embodiments of the token described herein is a certificate in the Web3 ecosystem that reflects the individual availability and participation in anything, such as, for example, governance, distributed applications, non-fungible tokens, real life activities, memberships, identifiers, or other verifications.

Exemplary embodiments of the digital residency platform and verification system and method may grant users different tiers of privileges, such as, for example, DAO quadratic vote and governance, recognized contributions in governance, delegate nomination and support. For example, significant token holders may have the ability to nominate ambassadors. The elected ambassadors may represent the community to negotiate terms with state and ecosystem partners.

Exemplary embodiments of the systems described herein may include a digital verification system having a user interface module; one or more application program interfaces; an identification verification module; and a wallet generation and communication to a blockchain open ledger module.

Exemplary embodiments of the verification systems described herein may include a method of creating a digital identification using a digital verification system, including providing a user interface using a user interface module of the digital citizen using a digital verification system; creating an identification through the user interface by receiving information about a user; creating a digital wallet using a wallet generation module of the digital citizen using the digital verification system; receiving a data file relating to an original identification document of the user; validating the original identification document of the user; and creating a non-fungible token for verification related to the sovereign jurisdiction and the identification.

The method may also or alternatively include any combination of additional steps or attributes, including, for example: generating a new identification document for the user and the jurisdiction; sending the new identification document to the user; encrypting the original identification document and sending to a jurisdiction system. In an exemplary embodiment, the data file is an image of the original identification document of the user, or the original identification document was issued by a sovereign jurisdiction to confirm an identity of the user.

Exemplary embodiments described herein may include a method of creating a digital identification using a digital verification system, including confirming a user identity; receiving information about the user; creating a digital identification as an nonfungible token (NFT); associating one or more claims with the NFT; storing the NFT in a user's wallet; and validating an attribute of the user using the claims associated with the NFT.

Exemplary embodiments described herein may include a method that includes additional features or steps as described herein. For example, the method may also or alternatively include any combination of determining one or more claims from the received information about the user; securing the NFT by hashing information of the NFT and storing the hash on an open ledger; or expunging personal information from the system after creation of the NFT. Exemplary embodiments may include features such as, for example, at least one of the claims of the one or more claims is related to a user's age grouping; and/or the NFT is configured to prevent transfer between user wallets, and/or the user identity is confirmed using identification documents that are authenticated, and/or information associated with the identification documents are expunged from the system after authentication.

Exemplary embodiments described herein may include a digital verification system including an application having a user interface module; identification verification module; and/or a digital wallet configured to communicate with a blockchain open ledger. The application may be configured to generate a nonfungible token (NFT) associated with the user and associate the NFT to the digital wallet of the user. The NFT may include metadata comprising claims, the claims contain information related to the user but do not provide specific information of the user. The claims may include information of the user in a hashed format. The claims may include an indication of an age grouping. The NFT may be configured to be non-transferable. The digital verification system may be configured through the NFT and/or entries written to the blockchain open ledger to minimize unauthorized modification of the NFT. The identification verification module may be configured to receive a digital copy of a physical identification document and an image or video of the user to confirm the identity of the user relative to the physical identification document. The claims may be stored in a metatdata URL. The claims may be configured to be retrieved using a json URL.

Exemplary embodiments described herein may include a system that includes additional features as described herein. For example, the system may also or alternatively include any combination of features for creating and/or determining one or more claims from the received information about the user; securing the NFT by hashing information of the NFT and storing the hash on an open ledger; or expunging personal information from the system after creation of the NFT. Exemplary embodiments may include features such as, for example, at least one of the claims of the one or more claims is related to a user's age grouping; and/or the NFT is configured to prevent transfer between user wallets, and/or the user identity is confirmed using identification documents that are authenticated, and/or information associated with the identification documents are expunged from the system after authentication.

Exemplary embodiments of the system described herein can be based in software and/or hardware. While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A digital verification system comprising:
a server comprising one or more processors and memory having stored thereon non-transitory machine instruction that when executed by the processors are configured to perform functions;
the non-transitory machine instructions comprising an application having a user interface module;
the non-transitory machine instructions comprising an identification verification module configured to receive a digital copy of a physical identification document and an image or video of a user to confirm the identity of the user relative to the physical identification document; and
a digital wallet of the user configured to communicate with a blockchain open ledger,
wherein the application is configured to generate a nonfungible token (NFT) associated with the user and associate the NFT to the digital wallet of the user.

2. The digital verification system of claim 1, wherein the NFT comprises metadata comprising claims, the claims contain information related to the user but do not provide specific information of the user.

3. The digital verification system of claim 2, wherein the claims include information of the user in a hashed format.

4. The digital verification system of claim 2, wherein the claims include an indication of an age grouping.

5. The digital verification system of claim 2, wherein the NFT is configured to be non-transferable, and the digital verification system is configured through the NFT and/or entries written to the blockchain open ledger to minimize unauthorized modification of the NFT.

6. The digital verification system of claim 4, wherein the identification verification module is configured to receive a digital copy of a physical identification document and an image or video of the user to confirm the identity of the user relative to the physical identification document.

7. The digital verification system of claim 1, wherein the claims are stored in a metadata URL.

8. The digital verification system of claim 1, wherein the claims are configured to be retrieved using a json URL.

9. A method of creating a digital identification using a digital verification system, comprising:
providing a user interface using a user interface module of the digital verification system;
creating an identification through the user interface by receiving information about a user;
creating a digital wallet using a wallet generation module of the digital verification system;
receiving a data file relating to an original identification document of the user;
validating the original identification document of the user; and
creating a non-fungible token for verification related to a sovereign jurisdiction and the identification.

10. The method of claim 9, further comprising generating a new identification document for the user and the sovereign jurisdiction.

11. The method of claim 10, further comprising sending the new identification document to the user.

12. The method of claim 11, further comprising encrypting the original identification document and sending to a jurisdiction system.

13. The method of claim 12, wherein the data file is an image of the original identification document of the user.

14. The method of claim 13, wherein the original identification document was issued by any sovereign jurisdiction to confirm an identity of the user.

15. A method of creating a digital identification using a digital verification system, comprising:
confirming a user identity of a user with the digital verification system;
receiving information about the user;
creating a digital identification as a nonfungible token (NFT);
associating one or more claims with the NFT;
storing the NFT in a user's digital wallet;
validating an attribute of the user using the claims associated with the NFT.

16. The method of claim 15, further comprising determining one or more claims from the received information about the user.

17. The method of claim 16, wherein at least one of the claims of the one or more claims is related to a user's age grouping.

18. The method of claim 16, further comprising securing the NFT by hashing information of the NFT and storing the hash on an open ledger.

19. The method of claim 18, wherein the NFT is configured to prevent transfer between user wallets.

20. The method of claim 19, wherein the user identity is confirmed using identification documents that are authenticated.

21. The method of claim 20, wherein information associated with the identification documents are expunged from the system after authentication.

22. The method of claim 21, further comprising expunging personal information from the system after creation of the NFT.
